(19) United States
(12) Patent Application Publication
(10) Pub. No.: US 2014/0279601 A1
(43) Pub. Date: Sep. 18, 2014

(54) System for Certifying Use of Acceptable Animal Husbandry Protocol

(71) Applicant: Glenn McClelland, Grand Junction, CO (US)

(72) Inventor: Glenn McClelland, Grand Junction, CO (US)

(21) Appl. No.: 13/840,058

(22) Filed: Mar. 15, 2013

(51) Int. Cl. G06Q 30/00

(52) U.S. Cl. CPC G06Q 30/018
USPC 705/317

(57) ABSTRACT

This system provides a rating related to livestock producers' compliance with certain animal husbandry protocols. The system accepts data from other systems or data entry related to movement and location of animals, certification of caretakers, management compliance statements, and documents pertaining to herd health. Additionally, the system provides means to remind employees when recertification is necessary and administer refresher courses to prepare the employee for recertification. Finally, the system can record onsite assessments and remind when they come due. Taking this information into account, the system generates a rating. This rating may be made available to entities outside the producer and signifies the level of compliance the producer has with the various animal well-being protocols imbedded in the system and measured by the activities reported.

### FIELD OF THE INVENTION

A system for communicating compliance with animal well being and husbandry protocol, safety, and quality control. More particularly, a system that allows a producer to manage risk by monitoring, tracking, reporting, and obtaining a rating all as relates to best practices, training, monitoring and accountability as recommended for animal welfare for the purpose of communicating with processors, packers, retailers and, perhaps, end purchasers.

### BACKGROUND

Although some producers may be in complete compliance with the applicable regulations and protocols recommended as industry standards or interest groups, to date there has been no system available to report that compliance. Instead, noncompliance of some has been widely publicized to the detriment of all producers. Further, an accusation of noncompliance is very difficult to counter without a system for tracking, reminding and reporting activities necessary for compliance. In the face of a negative event, such a system would help a producer to establish that such an event is not the norm, that it is an outlier and not indicative of the operation's overall management or approach to animal husbandry practices. Currently, when one negative event occurs it calls into question a producer's total approach and entire operation. It has heretofore been very difficult for a producer to establish that a negative event is an outlier, an isolated occurrence, and not the result of a systemic problem.

### SUMMARY

The present invention provides a systemic approach to risk management by providing a system that provides validation and certification that an appropriate system for training and managing employees to employ acceptable animal husbandry protocol is in place and is being applied. Without such a system, a producer may lose their marketing relationships with packer, and, perhaps retailer. Further, damage to the label on product that is sourced from a producer where such a negative event occurs and becomes publicized can be substantial.

The system of the present invention supports a producer's position that its employees and contractors are equipped to make correct choices for animal well being. The system accomplishes this by reminding, tracking and administering certain refresher courses and training opportunities for animal caretakers and, optionally, caretakers, and by collecting, analyzing and reporting data that establishes or confirms there are systems put in place by the producer aimed at reducing the incidence of any negative events. In addition to accepting and analyzing data related to compliance with certification requirements by animal caretakers, and providing educational courses related to those requirements, the present invention accepts and analyzes data that relates to compliance of staff with requirements to read and confirm agreement with certain position statements on a regular basis, compliance of visitors with requirements to agree to certain restrictions and reporting requirements. Further, the system accepts data relating to animal location and tracking for the purpose of certifying that each animal in a particular group has been cared for by animal caretakers that have been certified by the system. Finally, the system accepts and tracks reports of noncompliance by a producer and provides means to require resolution to any such report.

The system includes the definition of tools and activities which, when incorporated into a producer's operations, and data is uploaded to the system, provide the basis for evaluating the existence and use of these tools and activities and for communicating results from this evaluation. The data required by the system in order to provide a compliance rating includes: data relating to staff commitment to animal well-being; data relating to each employee that is an animal caretaker and that employee's certification status; data related to a given animal's location and transfers; data that shows that visitors are informed about acceptable protocols for interaction with the animals; data related to herd health such as veterinary evaluations, biosecurity protocols and enforcement, and rodent and pest control; data related to reporting and resolving reports of noncompliance with various standards; and, finally, data necessary to confirm completion of regular site assessments in compliance with PQAPlus as established by the National Pork Board. In addition, the system defines training and refresher courses for all employees whose positions require that employee to be one on one with animals (“caretakers”) and consistent with established best practices recommended or required by regional and national animal husbandry boards and/or organizations, Finally, the system includes a defined audit program designed to provide validation of the information provided to the system to support certification. In an embodiment, the system compiles the various data supplied by the producer, weights the data in accordance with a formula, and creates a single digit or letter rating which is designed to effectively communicate the status of a producer's compliance with the defined animal wellbeing management system requirements. This rating is then made available to, or sent to, packers, producers, retailers or others as the producer desires. The rating serves as a third party expression of the producer's compliance with the activities and validates the existence or lack of existence of the prescribed tools in the system. Further, the producer will be able to manage the entities who will be provided access to the reports and/or ratings provided by the system.

### DETAILED DESCRIPTION

The system is comprised of a system for accepting and using specific data generated by a producer, assessing, combining and evaluating that data, and generating a rating of that producer. The rating provides the producer and other users of the reported information an objective basis for evaluating the producer's systematic management of the wellbeing of animals in the producer's operation. The system employs data as a means to generate reminders, report participation, and record compliance with a plurality of compliance standards, using a plurality of tools to remind, track and record a plurality of activities and participation actions of management, employees, visitors, and contractors, any or all of which may be accomplished via data provided to the system via a single electronic means or a combination of several electronic means or a combination of electronic and physical means, for example, paper, hardcopy via on-line access or not; personal computer, mobile app, etc., via cloud computing methods, downloads, website access, etc.

Data accepted by the system includes at least the following:

Employee data identifying all employees that have contact with animals (hereafter referred to as caretakers), at which location the employee works if more than one location is managed by a producer, the date of hire, position, current certification status, date of last certification. Optionally, an employee ID number, date of birth, contact information, and status will be provided. This information is used by the system to manage certification requirements as will be discussed later.

Visitor compliance data which identifies all visitors, date and, preferably, time of entry and exit, and includes positive affirmation by the visitor that he was presented with and required to agree to comply with a statement regarding animal care before he was allowed to visit, and confirms the visitor saw no activities out of compliance with that statement while visiting.

Management compliance with periodic review of a statement of management's commitment to animal well-being is tracked by the system. The statement includes confirmation of inclusion of certain animal care practices in accordance with industry standards such as Pork Quality Assurance Plus (PQA+) and Transport Quality Assurance (TQA) guidelines. One embodiment requires data confirming periodic review once every thirty days.

Location specific information is uploaded or entered which includes inventory information, location and movement of animals as well as employee data related to employees at this location. This data includes information related to the location and movement of all animals between producer locations and to the packer. Includes, preferably, delivery date, load identification, shipped from, shipped to, and shipped by information. Preferably, the data includes identification of the transportation company and the driver's identification. Even more preferably, the data includes certification information related to the transportation company and the driver.

Management's approach to herd health is stored by the system as a set of documents. These may be accessed by packer's granted access. By making these documents available and requiring that the documents meet certain criteria, the system allows communication of these policies to employees, customers and others who have the need to know this information. The required elements which must be included in the set of documents to qualify for inclusion in this system definition include veterinary health evaluations, biosecurity protocols, rodent and pest control regimes, and cleaning and disinfecting procedures.

One embodiment includes information submitted via a hotline report capture feature which anonymously captures employee, contractor, or visitor concerns. A preferred embodiment also captures data related to acknowledgement of the report, resolution and closure of each incident. In one embodiment, the hotline report capture feature is an online system for passive reporting only; in other embodiments the online system includes sending updates to the reporter regarding the closing of the incident; in other embodiments the system is provided data via electronic scanning of completed written forms. Another embodiment records data provided by personnel trained to: determine the validity of the report, or obtain a resolution to the reported incident, or provide closure to the reporter, or to perform two or three of these functions.

Finally, the system accepts data related to site assessments completed and provides means to schedule site assessment visits by outside auditing agencies and to record results of an on-site assessment. For example, swine producers are required to schedule and allow a PQA Plus assessment every three years if the producer wants to maintain PQA Plus certification. Upon entry of data related to the most recent assessment, the system generates reminders for scheduling that assessment and, thereafter, records results of that assessment and dockets the next date due for assessment. Preferably, the system generates reminders to schedule a yearly assessment and records the reported completion of that assessment as well as records and reports changes in practices and operations.

In addition to collecting the above data via download, crossload, and/or data entry, the system includes management and administration of educational refresher courses and review courses for employees. The system can be set to remind employees to participate in a specified refresher course in order to complete the course by a set date. The reminders may be generated first relative to data indicating the last course completed and the date it was completed, and may be generated weekly in accordance with employees who have not completed the course, or based on some other periodic setting. The employee may participate in the refresher course required which may be available on-demand (or on-line or via physical or other electronic means). At or after the close of the course, the employee will be asked to submit answers to a number of questions related to the subject matter of the course. The system scores the answers and assesses a pass or fail based on those answers. Preferably, passing requires 85% correct. If failed, the system records (and may report the failure to the producer) the failure and generates a new set of reminders for retaking the refresher course and the quiz. In a preferred embodiment, the second time the system provides a refresher course it repeats the same refresher course, with different questions. This process may repeat until the employee masters the subject. The initial reminders for a refresher course may be generated based on an employee's hire date and/or last certification date. The system provides reports or messages to the Producer regarding employees due to take and pass refresher courses, and those overdue. If a staff member fails the course, and is beyond the recertification or refresher required deadline, they will report as overdue; if they are within the required timeframe, they will continue to report as due to take the course.

The system also reminds employees—and managers of these employees—of the need to certify or recertify in compliance with PQA Plus Certification and/or TQA Certification or other certifications which require attendance of a PQA Plus education program with a PQA Plus Advisor (or a TQA education program with a TQA Advisor) or requires participation in other certification classes. Reminders are sent preferably at least once weekly up to 8 weeks prior to the due date for recertification; the system reports to the Producer those within a given number of days of becoming noncompliant and again of any employees who are out of compliance.

Important to any system for reporting regarding compliance with good animal husbandry practices is a system for administering and certifying training participation of caretakers in acceptable Euthanasia practices. This system reminds each employee when he will need to participate in a course, optionally, the system administers to employees an on-line course or the course is provided by another course of study, preferably but not limited to once every six months. The course comprises the producer's Management's Approved Euthanasia Program. The course may be taken at the same time as a PQA Plus and/or TQA or other refresher course (combined or separately) and recorded by the system.

The system also accepts data comprising confirmation that each employee has done nothing, seen nothing or heard anything that would be in conflict with the statement of management's commitment to animal well-being. Or, if the employee knows of such an incident, confirmation that the incident was reported through the hot line report capture system or the confirmation is accompanied by a description of the incident.

In short, the system is set up to track and require certification of all persons whose job descriptions include one on one activities with animals, whether employees of the producer or contract workers, and provides sorting capability relative to compliance at a particular location.

Many different people may visit a producer's location in a given time frame. These may include a wide range of service providers, utility workers, loading and unloading personnel, veterinarians, repairmen, and tours of the facility. The Site Visitor Management Module may function in any one or more of several ways. For example, the system preferably receives either data related to the visit or a scanned form that includes the visitor's signature obtained prior to admittance to the facility or at time of admittance. In still other embodiments, if the visitor has previously completed the training and certification required by the system and has registered with the system, this visitor is then assigned a unique I.D. number which identifies him and confirms his compliance with the system requirements and allows him to enter the facilities and interact with the animals by only gaining permission from the producer. In all cases, the system's preferred embodiment also accepts data indicating the visitor re-affirms and/or confirms the statement when exiting the facility. Statements presented to the visitor preferably include or consist of confirmations issued by the producer related to their expectations for animal well-being protocols to be applied within their operations. In one preferred embodiment the statements include a confirmation and agreement by the visitor to report any activity he participates in which is not in compliance with the animal well-being protocols presented therewith and recording of the date and time of entry and exit of the premises.

The Hotline Report Capture System is a system providing tools for use by anyone. The system is preferably managed by an independent third party, relative to both the system and producer, but may instead be administered by either or a combination where data is collected by the producer and then provided to the system for tracking to confirm compliance. The Hotline Report Capture System allows someone to anonymously report any incidents related to animal welfare or animal husbandry protocols pertaining to the producer; the system generates an incident report which is then relayed to the producer for resolution. In one embodiment, the system then reminds the Producer that the incident is “open” until the Producer provides information indicating the incident is resolved or was addressed. All such reported incidents are required by the system to be closed by resolution or addressed; reminders of unresolved incident reports are generated and sent to the Producer as necessary.

If desired, a producer may elect to require its service providers (vets, etc.) to stay in compliance. The system is able to include nonemployees and generate reminders, quizzes and scores for individuals as well.

In any of the preferred embodiments of the system, the objective measurements of compliance with the above activities are weighted by the system and then combined by an algorithm to provide a Certified Systems Rating. Preferably, a rating is determined and assigned on a weekly basis although calculations and scoring may occur for different time periods, and averages may also be taken into account. The Weekly (or other periodic ratings) Ratings can be used by the Producer as warning and management systems. Through the system, the Producer may also provide access to the rating to various designated constituencies such as the packers, and, perhaps, the retailers of the end product. Each load of animals delivered for a producer to a particular packer is, therefore, certified via the system. In another embodiment, the packer is provided access to the system for the purpose of being able to record certification of each load, and can record even the producer's weekly ratings score for the week of delivery along with or in alternative to an overall rating and print a certificate comprising a load ID number, delivery date, producer ID, shipping location and tracker. These data can be delivered as a report to the Producer, the Packer or even to the retailer as long as such party has been granted specific access to this data by the Producer or packer whose operations are the subject of such data.

If the Packer elects to provide access to the system's ratings to retailers, the retailer purchasing from a particular packer will be able to obtain a rating for the overall supply of animals delivered to the packer which is supplying the retailer. These ratings, then, allow a retailer some comfort in knowing it is retailing meat products that are the output of operations that monitor animal well-being and require compliance by workers with national and other standards for animal well-being. The numeric rating provides a measure of the level of compliance.

If the producer wishes to use the system to track other information related to animal well-being, or other training or certifications unrelated to animal wellbeing, as described herein, the system is tailorable to add measurement but this additional data will not be taken into account to calculate the rating score provided to packers or retailers. Instead, the scores reported to packers and/or retailers by the system are all generated on exactly the same criteria to preserve meanings of the scores. In some embodiments, although the system will not take additional data into account when generating the standard scores, if the producer wishes some additional information from the system to be conveyed to the producer, it can so indicate and the third party may do so.

While the foregoing specification of this invention describes the invention in relation to certain preferred embodiments, it will be apparent to those skilled in the art that the invention is susceptible to additional embodiments and that certain of the details described herein may be varied considerably without departing from the basic principles of the invention. The invention may be used by producers, or required by packers, or required by retailers; additional modules or tools may be added to the invention; the invention may be used with nearly any growing product wherein husbandry and welfare protocols are desirable; refresher courses may be taken by an individual or may be provided in a group setting; the protocol compliance standards may be set by any number of national or regional boards, and may be complemented by a producer's own protocols and requirements, although such additions will not impact the certified rating generated by the system.

The invention claimed is:

1. A system for managing risks associated with and communicating compliance with at least one animal well-being protocol, said system comprising accepting information related to activities of a producer related to compliance with said at least one animal well-being protocol, recording said producer's actions evidencing compliance with said at least one animal well-being protocol, and generating a rating indicating a level of compliance by said producer with said at least one animal well-being protocol.

2. The system of claim 1 wherein said at least one animal well-being protocol comprises certification of at least one employee, said information related to activities comprising: accepting information related to employee certification of at least one employee of said producer, generating reminders related to recertification of said at least one employee, and recording participation in required activities for recertification of said at least one employee.

3. The system of claim 1 further comprising means to record and report results generated by said system.

4. The system of claim 1 wherein said plurality of activities include a confirmation by at least one management member of at least one statement of commitment to animal well-being, and certification of at least one employee by completion of specified

5. The system of claim 1 wherein said plurality of activities comprises certification of at least one employee of compliance with a plurality of certification requisites wherein said system generates at least one reminder to said at least one employee to participate in at least one refresher course, said system administers a refresher course to said employee and administers and scores a set of quiz questions related to said refresher course.

6. The system of claim 1 wherein said plurality of actions comprises administering at least one refresher course, at least one set of quiz questions related to said refresher course, and generating at least one reminder.

7. The system of claim 1 wherein said plurality of activities comprises certification of completion of euthanasia protocol training by at least one employee.

8. The system of claim 1 wherein said plurality of activities comprises provision of at least one document related to a herd health policy stored by said system for access by others.

9. The system of claim 8 wherein said at least one document includes at least one from the group consisting of veterinary health evaluations, biosecurity protocols, rodent and pest control regimes, and cleaning and disinfecting procedures.

10. The system of claim 2 wherein certification of said at least one employee includes completion of at least one assigned refresher course.

11. The system of claim 10 wherein said completion of at least one assigned refresher course comprises correct responses to a specific proportion of a plurality of questions.

12. The system of claim 1 wherein accepting information comprises accepting information from at least one from a group consisting of personal computer, web applications, mobile devices, cloud computing

13. A system for managing risks associated with and communicating compliance with at least one animal well-being protocol, said system comprising accepting information related to a plurality of activities of a producer related to compliance with at least one animal well-being protocol and generating a rating indicating a level of compliance with said protocol.

14. The system of claim 13 wherein said at least one protocol comprises accepting data related to tracking location and movement of a plurality of animals.

15. The method of claim 13 wherein said protocol further comprises accepting and using data related to transportation of said plurality of said animals and certification information related to certification of an entity transporting said animals and its personnel.

16. The system of claim 13 wherein said at lest one protocol comprises accepting data related to a visitor and said visitor's positive affirmation regarding agreement to comply with a statement regarding animal care.

17. The system of claim 13 wherein said plurality of activities comprises a hotline report capture feature for capturing reported concerns and capturing and reporting data related to resolution of said concern.

18. A method for managing risks associated with and communicating compliance with at least one animal well-being protocol, said method comprising:
a) accepting data related to tracking movement and certification of transporters of a plurality of animals;
b) certifying at least one employee comprising administering at least one refresher course;
c) generating reminders for employee due to be recertified and recording date of recertification;
d) recording confirmation by at least one member of management of a statement of commitment to animal well being; and
e) storing and making selectively available at least one document pertaining to any one or more of the group comprising veterinary health evaluation, biosecurity protocols, rodent and pest control regimes, and cleaning and disinfecting procedures.

19. The system of claim 2 comprising certification of said employee by completion of certification requisites wherein said requisites include completion of at least one of a refresher course and a set of quiz questions.

20. The system of claim 19, said refresher course conducted in a classroom setting.

21. The system of claim 19 where said set of quiz questions comprises on-line testing.

22. The system of claim 19 where said set of quiz questions comprises a mobile application.

23. The system of claim 1 wherein said rating assigned by said third party is provided to a packer selected by said producer.

24. The system of claim 1 wherein said rating is compiled weekly.

25. The system of claim 1 wherein said animal well-being protocols comprise protocols set by a governmental body.

26. The system of claim 1 wherein said animal well-being protocols comprise protocols set by a national board.

27. The system of claim 1 wherein said plurality of activities include a confirmation by at least one employee of at least one statement of commitment to animal well-being, and certification by said employee of reporting any incident observed in conflict with said statement.
